(19) United States
(12) Patent Application Publication
(10) Pub. No.: US 2012/0013188 A1
(43) Pub. Date: Jan. 19, 2012

(54) POWER SUPPLY SYSTEM AND CONTAINER DATA CENTER INCLUDING THE SAME

(75) Inventors: YAO-TING CHANG, Tu-Cheng (TW); CHAO-KE WEI, Tu-Cheng (TW)

(73) Assignee: HON HAI PRECISION INDUSTRY CO., LTD., Tu-Cheng (TW)

(21) Appl. No.: 12/871,940

(22) Filed: Aug. 31, 2010

(30) Foreign Application Priority Data
Jul. 14, 2010 (TW) 99123223

(51) Int. Cl. H02J 7/34; H02N 2/18

(52) U.S. Cl. 307/48; 310/339

(57) ABSTRACT

A power supply system includes a road electricity generating apparatus, a battery, and a voltage converter. The road electricity generating apparatus is installed in a road. The road electricity generating apparatus includes a number of piezoelectric crystals connected in series to convert potential energy of passing vehicles to electricity. The battery stores the electricity generated by the piezoelectric crystals. The voltage converter converts the electricity of the battery to a desired working voltage for the container data center.

### BACKGROUND

1. Technical Field

The present disclosure relates to a power supply system and a container data center including the power supply system.

2. Description of Related Art

A power supply system converts the voltage from a commercial power source to a certain voltage and supplies power to a container data center. However, electricity is wasted in transmitting the power over long distances from a power station to the container data center.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of an exemplary embodiment of a power supply system including a road electricity generating apparatus.

FIG. 2 is a schematic view of the road electricity generating apparatus of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

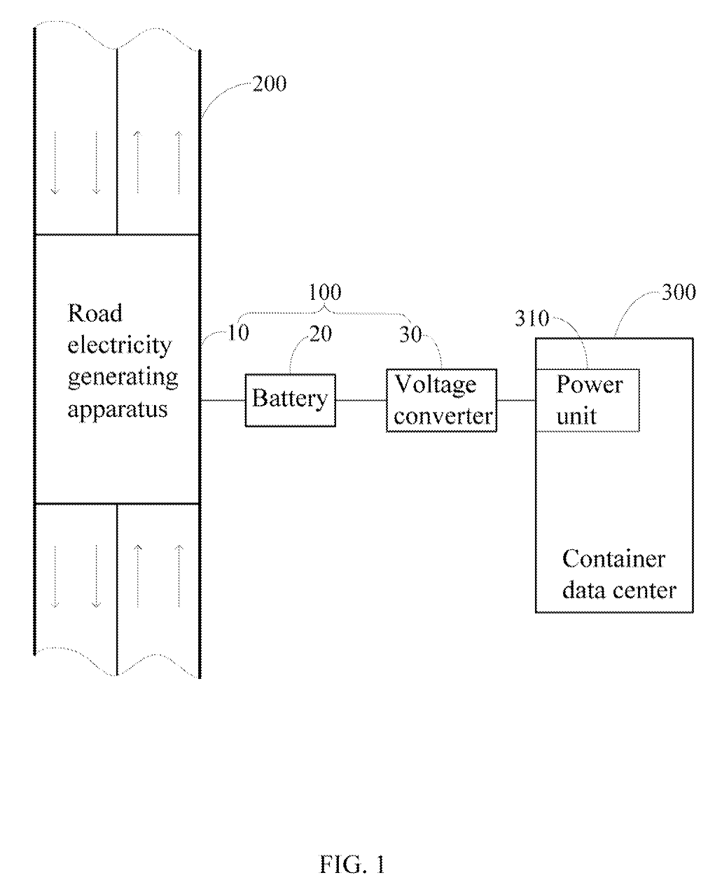

Referring to FIG. 1, an exemplary embodiment of a power supply system 100 includes a road electricity generating apparatus 10, a battery 20, and a voltage converter 30.

The road electricity generating apparatus 10 is installed in, on, or under a road 200 in such a way that portions of the apparatus 10 are compressed by passing vehicles driving on the road 200.

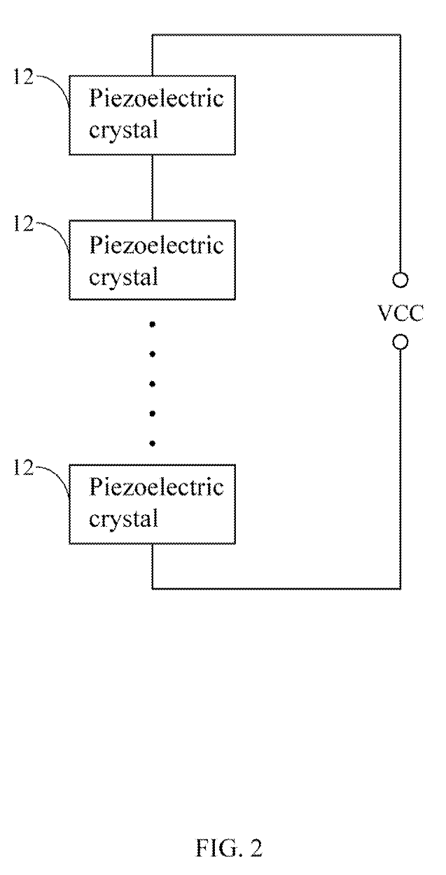

Referring to FIG. 2, the portions of the road electricity generating apparatus 10 referred to above include a plurality of piezoelectric crystals 12 connected in series.

A first terminal of the battery 20 is connected to the road electricity generating apparatus 10. A second terminal of the battery 20 is connected to a first terminal of the voltage converter 30. A second terminal of the voltage converter 30 is connected to a power unit 310 of a container data center 300.

The piezoelectric crystals 12 are compressed by passing vehicles driving on the road 200, thus converting potential energy to electricity.

The battery 20 stores the electricity generated by the piezoelectric crystals 12.

The voltage converter 30 converts voltage of the stored electricity to a desired working voltage and then supplies the working voltage to the container data center 300.

In the embodiment, the container data center 300 is placed near the road electricity generating apparatus 10. Thus, the distance between the power source to where it is put to use is short, reducing waste. Furthermore, external surfaces of the container data center 300 may be used as visual mediums for such things as advertising, and traffic and weather information for drivers.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A power supply system, comprising:
a road electricity generating apparatus set on a road, and comprising a plurality of piezoelectric crystals connected in series to convert potential energy of vehicles passing along the road into electricity;
a battery connected to the road electricity generating apparatus, to store the electricity generated by the plurality of piezoelectric crystals; and
a voltage converter connected between the battery and a power unit of a container data center, the voltage converter converts the electricity of the battery to the working voltage matching the container data center and supply power to the container data center.

2. A container data center, comprising:
a power supply system, wherein the power supply system comprises:
a road electricity generating apparatus set on a road, and comprising a plurality of piezoelectric crystals connected in series to convert potential energy of vehicles passing along the road into electricity;
a battery connected to the road electricity generating apparatus, to store the electricity generated by the plurality of piezoelectric crystals; and
a voltage converter connected to the battery, to convert the electricity of the battery to the working voltage of the container data center; and
a power unit connected to the battery to receive the working voltage.

3. The container data center of claim 2, wherein the container data center is placed near the road.
